(19) United States
(12) Patent Application Publication
(10) Pub. No.: US 2013/0169551 A1
(43) Pub. Date: Jul. 4, 2013

(54) SHOWCASE

(71) Applicants: Ki-Seok Park, Seoul (KR); Min-Joong Kim, Seoul (KR)

(72) Inventors: Ki-Seok Park, Seoul (KR); Min-Joong Kim, Seoul (KR)

(73) Assignee: Sigongtech Co., Ltd., Gyeonggi-do (KR)

(21) Appl. No.: 13/483,735

(22) Filed: May 30, 2012

(30) Foreign Application Priority Data
Jan. 3, 2012 (KR) 10-2012-0000385

(51) Int. Cl. G06F 3/041

(52) U.S. Cl. 345/173

(57) ABSTRACT

Disclosed herein is a showcase for displaying an exhibit therein. The showcase includes a first display unit and a second display unit. The first display unit is located on one side of the exhibit, is formed of a transparent touch panel, and displays information about the exhibit thereon. The second display unit is located such that the exhibit can be interposed between the first display unit and the second display unit, is placed opposite the first display unit, and displays an image related to the exhibit.

### CROSS REFERENCE TO RELATED APPLICATION

This application claims the benefit of Korean Patent Application No. 10-2012-0000385, filed on Jan. 3, 2012, which is hereby incorporated by reference in its entirety into this application.

### BACKGROUND OF THE INVENTION

1. Technical Field

The present invention relates generally to a showcase and, more particularly, to a showcase that is capable of providing customized information about an exhibit to viewers and increasing the understanding and interest of viewers in an intuitive manner.

2. Description of the Related Art

Showcases are used to display exhibits, such as antiquities or products, in places, such as museums, department stores or exhibition halls, and to show them to viewers. Most showcases are formed of casings whose sides are made of glass, and are formed in display exhibits therein.

Such showcases allow a variety of information about exhibits to be separately provided on the fronts or sides thereof; thereby providing the information to viewers. Accordingly, such showcases are problematic in that they cannot provide large amounts of information about exhibits, for example, the historical background of specific antiquities, images of similar products, and the features of shapes. That is, since such a showcase separately provides information about an exhibit on one side thereof, it is impossible to reliably provide a large amount of information about the exhibit. Furthermore, such showcases have limitations imposed on the presentation of customized information about exhibits to viewers.

As a result, since viewers cannot be provided with sufficient information about exhibits, inconvenience arises in that pamphlets may have to be provided to offer more detailed information, or libraries or Internet searches may have to be utilized to obtain more detailed information.

### SUMMARY OF THE INVENTION

Accordingly, the present invention has been made keeping in mind the above problems occurring in the prior art, and an object of the present invention is to provide a showcase which is capable of providing customized information to viewers who are viewing an exhibit. That is, the present invention enables viewers to actively search for and view information about an exhibit via touch manipulation of a transparent touch panel, thereby providing customized information about the exhibit to the viewers in an intuitive manner.

Another object of the present invention is to provide a showcase which is capable of replacing information and an image related to an exhibit and displaying new information and a new image on first and second display units in response to a viewer's touch manipulation, thereby providing a variety of information to viewers.

Furthermore, still another object of the present invention is to provide a showcase which is capable of increasing the understanding and interest of viewers.

In order to accomplish the above object, the present invention provides a showcase for displaying an exhibit therein, including a first display unit located on one side of the exhibit, formed of a transparent touch panel, and configured to display information about the exhibit thereon; and a second display unit located such that the exhibit can be interposed between the first display unit and the second display unit, placed opposite the first display unit, and configured to display an image related to the exhibit.

The first display unit may display the information about the exhibit in response to a viewer's touch manipulation of the first display unit.

The second display unit may replace the image related to the exhibit and display a new image in response to the viewer's touch manipulation of the first display unit.

The location where the information about the exhibit is displayed on the first display unit and the location where the image related to the exhibit is displayed on the second display unit, with respect to a location of the exhibit, may be determined after taking into consideration the location of a viewer who is viewing the exhibit.

The location where the information about the exhibit is displayed on the first display unit and the location where the image related to the exhibit is displayed on the second display unit, with respect to a location of the exhibit, may be determined by tracking the viewer's eyes.

The first display unit may be located on one surface of a showcase body having a hexagonal vertical section, and the second display unit may be located on another surface of the showcase body which is opposite to the one surface.

The first display unit may be located on one surface of a showcase body having a rectangular vertical section, and the second display unit may be located on another surface of the showcase body which is opposite to the one surface.

The first display unit may display an opaque background image and display the information about the exhibit based on the opaque background image in response to a viewer's predetermined touch manipulation of the first display unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a showcase according to an embodiment of the present invention;

FIG. 2 is a side view showing an example of the showcase according to the embodiment of the present invention;

FIG. 3 shows a showcase body, a first display unit, an exhibit and a second display unit which are seen when a viewer views the exhibit inside the showcase according to the embodiment of the present invention;

FIG. 4 separately shows a screen which is displayed on the first display unit in FIG. 3;

FIG. 5 separately shows a screen which is displayed on the second display unit in FIG. 3; and

FIG. 6 is a perspective view of a showcase according to another embodiment of the present invention.

### DESCRIPTION OF THE PREFERRED EMBODIMENTS

The present invention will be described in detail with reference to the accompanying drawings below. Here, when the description is redundant and detailed descriptions of well-known functions or configurations would unnecessarily obscure the gist of the present invention, the detailed descriptions will be omitted. The embodiments of the present invention are provided to complete the explanation for those skilled in the art of the present invention, Therefore, the shapes and sizes of components in the drawings may be exaggerated to provide a more precise description.

The configuration and operation of a showcase 100 according to an embodiment of the present invention will be described in detail below.

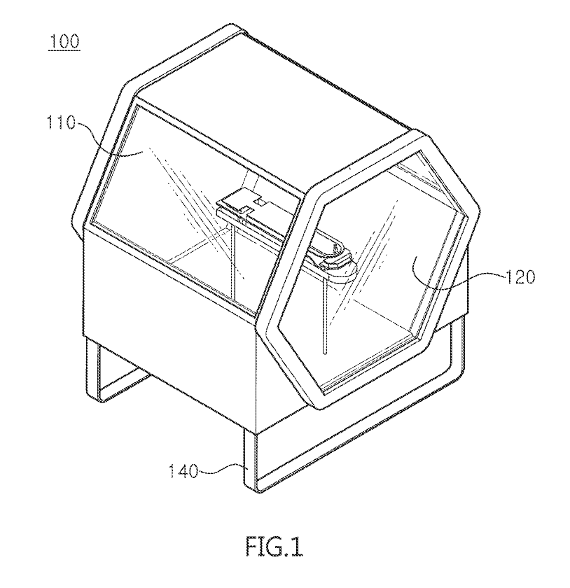

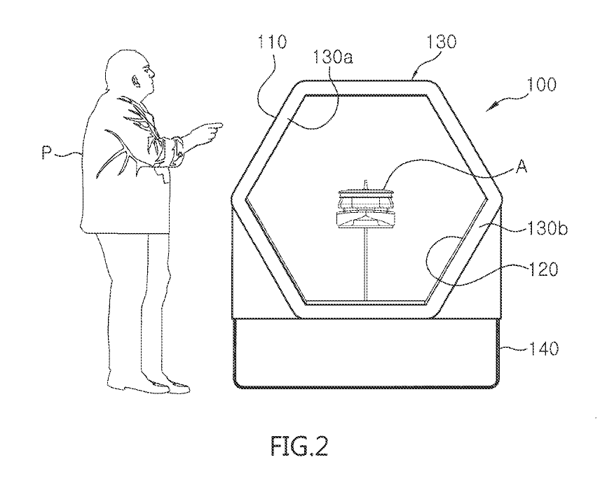

FIG. 1 is a perspective view of the showcase 100 according to the embodiment of the present invention. FIG. 2 is a side view showing an example of the showcase 100 according to the embodiment of the present invention.

Referring to FIGS. 1 to 2, the showcase 100 according to the embodiment of the present invention includes a first display unit 110, a second display unit 120, and a showcase body 130. Furthermore, the showcase 100 according to the embodiment of the present invention further includes a support 140 and an eye tracking unit (not shown).

The first display unit 110 is located on one side of an exhibit A, and is formed of a transparent touch panel. Furthermore, the first display unit 110 displays information about the exhibit A on the transparent touch panel. When a viewer P views the exhibit A, he or she views the exhibit A through the first display unit 110. In this case, the first display unit 110 displays information about the exhibit A in response to the viewer P's touch manipulation of the first display unit 110. Furthermore, a variety of types of menu icons related to information about the exhibit A may be formed on the first display unit 110, and the information about the exhibit A may be replaced and then new information may be displayed in response to the viewer P's manipulation of each menu icon. Furthermore, the first display unit 110 may display an opaque image (for example, a black image) and then display information about the exhibit A based on the opaque image in response to the viewer P's predetermined touch manipulation of the first display unit 110. Compared to the case where the first display unit 110 displays an image based on a transparent image, this case allows the first display unit 110 to display just an opaque image, so that the viewer P can focus on viewing only information displayed on the first display unit 110 without viewing the exhibit A.

The second display unit 120 is located opposite the first display unit 110 so that the exhibit A can be interposed between the first display unit 110 and the second display unit 120. Furthermore, the second display unit 120 displays an image related to the exhibit A. Furthermore, the second display unit 120 is controlled such that the image related to the exhibit A is replaced and then a new image is displayed, in response to the viewer P's touch manipulation of the first display unit 110. The image related to the exhibit A which is displayed by the second display unit 120 may be an image of the background or background knowledge of the exhibit A. That is, when the exhibit A is a model of a ship, an image of the sea, an island or a shipyard may be displayed on the second display unit 120. Although the second display unit 120 may be formed of a Liquid Crystal Display (LCD) screen or a Light Emitting Diode (LED) screen, this does not mean that the type of second display unit 120 is limited thereto. Furthermore, an image of a menu icon which is a target of the viewer's touch manipulation of the first display unit 110 may be displayed on the second display unit 120.

The location where information about the exhibit A is displayed on the first display unit 110, with respect to the location of the exhibit A, and the location where an image related to the exhibit A is displayed on the second display unit 120, with respect to the location of the displayed exhibit A, may be determined after taking into consideration the location of the viewer P who is viewing the exhibit A. In this case, the location of the viewer P may be taken into consideration using the eye tracking unit which is installed on one side of the showcase 100 to track the viewer P's eyes. In particular, when an image of menu icons which are targets of the viewer's touch manipulation of the first display unit 110 is displayed on the second display unit 120, a touch location on the first display unit 110, at which each menu icon is selected on the second display unit 120, may he determined after taking into consideration the viewer P's eyes.

The showcase body 130 has a hexagonal vertical section, and is formed such that the exhibit A is located therein. Furthermore, the first display unit 110 may be located on one surface 130 of the showcase body 130, the view of which is unhindered when the viewer P views the exhibit A. Moreover, the second display unit 120 may be located on another surface 130b of the showcase body 130 which is opposite to the surface 130a.

The support 140 may be formed on one side of the showcase body 130 to support the showcase body 130. The support 140 is formed to adjust the location of the showcase body 130 so that the viewer P can comfortably view the exhibit A located inside the showcase body 130.

Images which are displayed on the first and second display units in the showcase according to the embodiment of the present invention will be described in detail below.

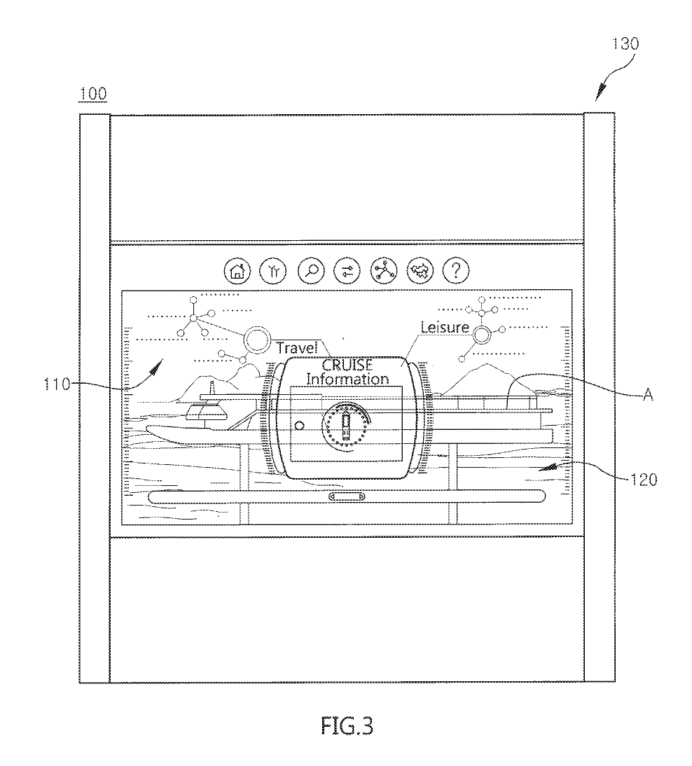

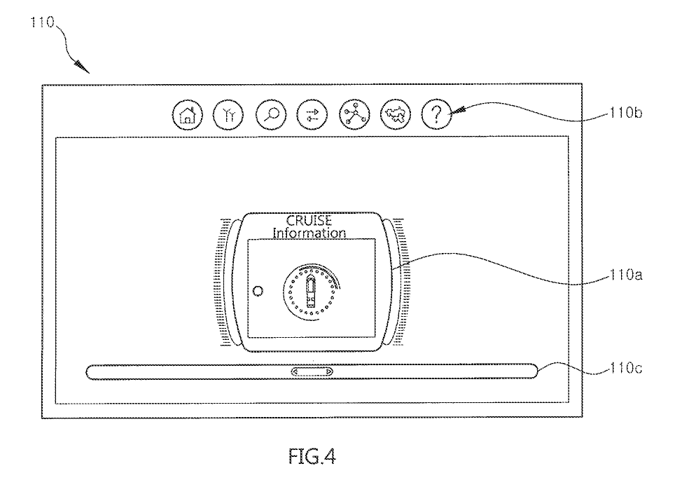

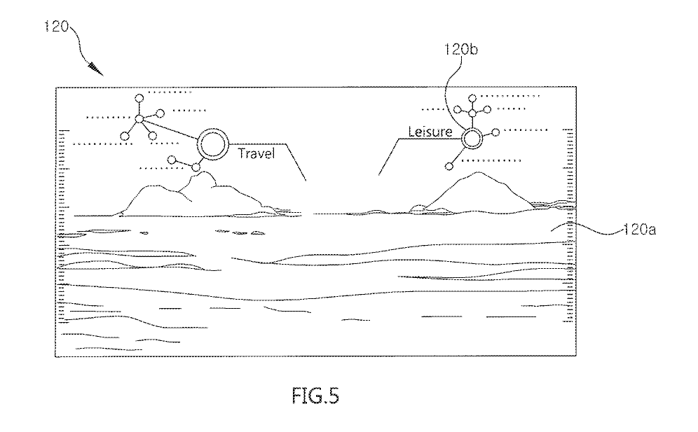

FIG. 3 shows the showcase body 130, the first display unit 110, the exhibit A and the second display unit 120 which are seen when the viewer P views the exhibit A inside the showcase 100 according to the embodiment of the present invention. FIG. 4 separately shows a screen which is displayed on the first display unit 110 in FIG. 3. FIG. 5 separately shows a screen which is displayed on the second display unit 120 in FIG. 3.

Referring to FIG. 3, when the viewer P of FIG. 2 views the exhibit A through the first display unit 110, the exhibit A and images which are seen by the viewer P are shown. That is, the viewer P can view an image on the first display unit 110, the exhibit A and an image on the second display unit 120, which are sequentially located, at the same time.

Referring now to FIG. 4, information 110a about the exhibit A is displayed on the transparent touch panel of the first display unit 110, and user interfaces, including menu icons 110b configured to enable the viewer P to retrieve desired information related to the exhibit A and a scroll bar 110 configured to help move information displayed on the first display unit 110, may also be displayed thereon.

Furthermore, referring to FIG. 5, the image related to the exhibit A is displayed on the second display unit 120. That is, when the exhibit A is a model of a ship, a background image 120a including the sea and an island may be displayed. Furthermore, menu icons 120b which are targets of the viewer's touch manipulation of the first display unit 110 may be displayed on the second display unit 120.

Images, such as user interfaces, which are displayed on the first and second display units 110 and 120 may be formed in a variety of ways, and are not limited to those described above.

The configuration and operation of a showcase 200 according to another embodiment of the present invention will be described below.

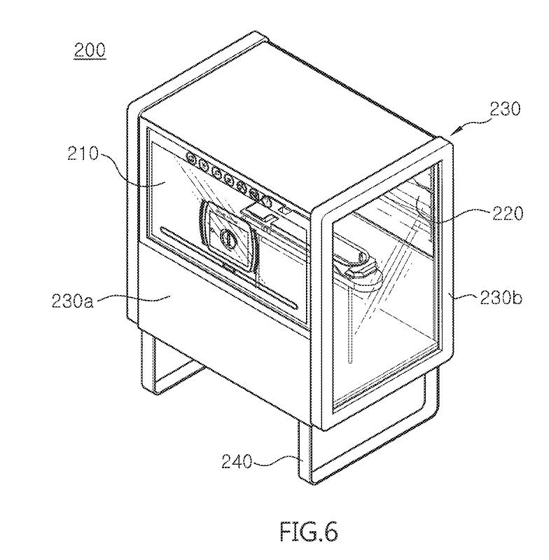

FIG. 6 is a perspective view of the showcase according to the other embodiment of the present invention.

Referring to FIG. 6, the showcase 200 according to the other embodiment of the present invention includes the showcase 200 and a showcase body 230 which are different from those shown in FIGS. 1 through 5. Accordingly, the showcase 200 according to the other embodiment of the present invention will be described with a focus on the showcase body 230. The same names are used for components which are the same as those of the showcase 100 shown in FIGS. 1 through 5, and detailed descriptions thereof will be omitted here.

The showcase 200 according to the other embodiment of the present invention may include a first display unit 210, a second display unit 220, and a showcase body 230. Furthermore, the showcase 200 according to the other embodiment of the present invention may further include a support 240 and an eye tracking unit (not shown).

The showcase body 230 has a rectangular vertical section, and is formed such that an exhibit can be located therein. Furthermore, the first display unit 210 may be located on one surface 230a of the showcase body 230, the view of which is unhindered when a viewer is viewing the exhibit. Moreover, the second display unit 220 may be located on another surface 230b of the showcase body 230 which is opposite to the surface 230a.

The present invention has the advantage of providing customized information to viewers who view an exhibit. That is, the present invention enables viewers to actively search for and view information about an exhibit via touch manipulation of a transparent touch panel, thereby providing customized information about the exhibit to the viewers in an intuitive manner.

The present invention has the advantage of replacing information and an image related to an exhibit and displaying new information and a new image on first and second display units in response to a viewer's touch manipulation, thereby providing a variety of information to viewers.

Furthermore, the present invention has the advantage of increasing the understanding and interest of viewers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A showcase for displaying an exhibit therein, comprising:
a first display unit located on one side of the exhibit, formed of a transparent touch panel, and configured to display information about the exhibit thereon; and
a second display unit located such that the exhibit can be interposed between the first display unit and the second display unit, placed opposite the first display unit, and configured to display an image related to the exhibit.

2. The showcase of claim 1, wherein the first display unit displays the information about the exhibit in response to a viewer's touch manipulation of the first display unit.

3. The showcase of claim 2, wherein the second display unit replaces the image related to the exhibit and displays a new image in response to the viewer's touch manipulation of the first display unit.

4. The showcase of claim 1, wherein, a location where the information about the exhibit is displayed on the first display unit and a location where the image related to the exhibit is displayed on the second display unit, with respect to a location of the exhibit, are determined after taking into consideration a location of a viewer who is viewing the exhibit.

5. The showcase of claim 4, wherein the location where the information about the exhibit is displayed on the first display unit and the location where the image related to the exhibit is displayed on the second display unit, with respect to a location of the exhibit, are determined by tracking the viewer's eyes.

6. The showcase of claim 1, wherein the first display unit is located on one surface of a showcase body having a hexagonal vertical section, and the second display unit s located on another surface of the showcase body which is opposite to the one surface.

7. The showcase of claim 1, wherein the first display unit is located on one surface of a showcase body having a rectangular vertical section, and the second display unit is located on another surface of the showcase body which is opposite to the one surface.

8. The showcase of claim 1, wherein the first display unit displays an opaque background image and displays the information about the exhibit based on the opaque background image in response to a viewer's predetermined touch manipulation of the first display unit.
